(19) United States
(12) Patent Application Publication
(10) Pub. No.: US 2011/0261175 A1
(43) Pub. Date: Oct. 27, 2011

(54) MULTIPLE CHANNEL IMAGING SYSTEM AND METHOD FOR FLUORESCENCE GUIDED SURGERY

(75) Inventors: Pavel A. FOMITCHOV, New York, NY (US); Liqin WANG, Belle Mead, NJ (US); Shaohong WANG, Belle Mead, NJ (US)

(73) Assignee: General Electric Company

(21) Appl. No.: 12/765,193

(22) Filed: Apr. 22, 2010

(51) Int. Cl. H04N 7/18

(52) U.S. Cl. 348/61; 348/E07.085

(57) ABSTRACT

The invention relates to an imaging system for use in operating rooms and other applications. According to one example, the imaging system includes a plurality of imaging sensors that receive image information from a subject via a plurality of spectral channels and that convert the image information into an image signal. The imaging system may include a plurality of independent imaging optics systems, such as an independent visible imaging optics system and an independent fluorescent imaging optics system, that optically couple the image information to the plurality of imaging sensors. The plurality of independent imaging optics systems corresponds to the plurality of image sensors in order to independently adjust a plurality of optical parameters, such as a size of a field of view, a position of a focal plane, and a size of an optical aperture. The imaging system may further include a plurality of motion controllers that independently control the plurality of independent imaging optics systems and a control unit that is configured to receive the image signals from the plurality of imaging sensors and to generate a plurality of image frames for transmission to a display device.

### FIELD OF THE INVENTION

The present invention relates generally to medical imaging and more particularly to image processing systems and methods for surgical and other applications.

### BACKGROUND

Various medical imaging systems and methods have been developed to assist surgeons in performing surgical procedures. For example, fluorescence guided surgical imaging systems allow surgeons to see anatomy and fluorescence-marked body areas simultaneously, with high spatial resolution, and in real time. Fluorescence guided surgical imaging technology is based on the use of fluorescent dyes that are injected into human tissue to visualize specific areas of the body, such as blood vessels, tumors, the urinal tract, etc. Fluorescence guided surgical imaging technology can provide relatively deep imaging depth into body tissue, minimal autofluorescence, reduced scatter, and high optical contrast. The images provided by a fluorescence guided surgical imaging system may be displayed on one or more display devices in an operating room for visual guidance for the surgeon.

Known fluorescence guided surgical imaging systems provide two images (a visible image and a fluorescent image). The fluorescence guided surgical imaging systems utilize a single optical system (a single zoom lens imaging system) providing a single optical path to form an image of the surgical field of view. The single optical system splits the image to obtain visible images and fluorescent images. However, this system design has some limitations. For example, known systems require extra components, such as relay lenses, in order to form spectrally filtered images on the fluorescent video camera and the color video camera. Further, the visible images and fluorescent images of known fluorescence guided surgical systems may have conflicting optical requirements, and therefore adjustment of the single optical system in order to improve the visible images may reduce the quality and/or the usability of the fluorescent images, and vice versa. For example, the depth of field for the visible images may be increased by reducing the aperture of the imaging lenses; however, the intensity of the fluorescent images may thereby be reduced and thus the sensitivity of the fluorescent detection will be lowered. Also, the visible images may have a wide field of view to achieve easy orientation for the surgeons; however, the fluorescent images then cannot zoom in to the feature of interest.

The present invention addresses these and other limitations of known fluorescence guided surgical imaging systems.

### SUMMARY

The invention relates to a fluorescence guided surgical imaging system for providing images of an organism or other subject. According to one example, the fluorescence guided surgical imaging system comprises an independent visible (e.g., color or black and white) imaging optics system and an independent fluorescent imaging optics system co-axially aligned to eliminate angular misalignment of the field of view. The visible imaging optics system may be configured to receive images from a visible spectral channel and the fluorescent imaging optics system may be configured to receive images from a fluorescent spectral channel. The visible imaging optics system may include a visible filter, an adjustable aperture, a visible zoom lens and/or a visible focus lens optically coupled to a visible image sensor configured to receive image information from an organism or other subject and may convert the image information into an image signal to be displayed on a display. The visible imaging optics system may independently adjust a plurality of optical parameters including at least one of size of a field of view, a position of a focal plane, and a size of an optical aperture and not affecting imaging parameters of the fluorescent imaging optics system.

The fluorescent imaging optics system may include a fluorescent filter, an adjustable aperture, a fluorescent zoom lens and/or a fluorescent focus lens optically coupled to a fluorescent image sensor configured to receive image information from an organism or other subject and may convert the image information into an image signal. The fluorescent imaging optics system may independently adjust a plurality of optical parameters including at least one of size of a field of view, a position of a focal plane, and a size of an optical aperture and not affecting imaging parameters of the visible imaging optics system.

The fluorescence guided surgical imaging system may also comprise one or more dichroic mirrors or dichroic filters configured to allow the visible image information to pass while reflecting the fluorescent image information. The fluorescence guided surgical imaging system may further comprise a mirror configured to redirect an optical path of the image information from the organism. The fluorescence guided surgical imaging system may also comprise a plurality of motion controllers that independently control the plurality of independent optical components.

The fluorescence guided surgical imaging system may comprise a control unit, such as a computer control workstation, that receives the respective image signals from the visible imaging optics system and the fluorescent imaging optics system. The control unit may comprise a processor programmed to control the operation of the fluorescence guided surgical imaging system and to generate a plurality of image frames for transmission to a display device or to a video interface designed to transmit the plurality of image frames to the display device.

The fluorescence guided surgical imaging system may allow, for each of the visible spectral channel and the fluorescent spectral channel, independent control of the size of the field of view, the position of the focal plane, and the size of the optical aperture. Independent control of these parameters for both the visible spectral channel and the fluorescent spectral channel allows for enhanced image quality for each channel. The system can be configured to automatically control these parameters to provide a desired size of the field of view, focus, and depth of field, or the system can be configured to allow the user to manually adjust these parameters. The ability to control the size of the field of view and the focus can be provided by a zoom lens and a separate focusing lens, or it can be provided by a variable focal length zoom lens.

The fluorescence guided surgical imaging system may comprise a white light source that may be configured to illuminate a surgical field with visible light to generate a first image, and at least one fluorescent excitation light source that may be configured to generate light to excite a fluorescent substance in an organism within the surgical field to generate a second image. The fluorescence guided surgical imaging system may also comprise a plurality of imaging sensors that may receive the first image and the second image from the surgical field via a plurality of spectral channels including, for example, at least one independent visible imaging optics system and at least one independent fluorescent imaging optics system, that optically couple the surgical field to the plurality of imaging sensors. The plurality of independent imaging optics systems may correspond to the plurality of image sensors in order to independently adjust a plurality of optical parameters.

The invention also relates to a method of generating an image with a fluorescence guided surgical imaging system. According to one embodiment, the method comprises providing a white light source that may be configured to illuminate a surgical field with visible light to generate a first image and providing at least one fluorescent excitation source that may be configured to generate light to excite a fluorescent substance in an organism within the surgical field to generate a second image. The method of generating an image by the fluorescence guided surgical imaging system may also comprise providing a plurality of imaging sensors that may receive the first image and the second image from the surgical field via a plurality of spectral channels, and providing a plurality of independent imaging optics systems comprising at least one of an independent visible imaging optics system and an independent fluorescent imaging optics system that optically couple the surgical field to the plurality of imaging sensors, wherein the plurality of independent imaging optics systems may correspond to the plurality of image sensors in order to independently adjust a plurality of optical parameters including at least one of a size of a field of view, a position of a focal plane, and a size of an optical aperture. The method may further comprise providing a plurality of motion controllers that may independently control the plurality of independent imaging optics systems and providing a control unit that may be configured to receive the image signal from the plurality of imaging sensors to generate a plurality of image frames for transmission to a display device.

According to some embodiments of the invention, the fluorescence guided surgical imaging system may be configured to independently control the size of the field of view, the position of the focal plane, and the size of the optical aperture for each of the visible channel and the fluorescent channel. According to other embodiments of the invention, some, but not all, of these optical parameters are independently controlled. For example, the system may be configured to independently control the size of the field of view and the size of the aperture for each of the visible channel and the fluorescent channel, but to control focus for both the visible and fluorescent channel.

According to other embodiments of the invention, the fluorescence guided surgical imaging system may comprise more than one visible channel and/or more than one fluorescent channel. For example, the system may include a single visible channel, a first fluorescent channel configured to excite and detect a first fluorescent substance in a patient, and a second fluorescent channel configured to excite and detect a second fluorescent substance in the patient.

### BRIEF DESCRIPTION OF THE DRAWINGS

These and other features and aspects of exemplary embodiments of the invention will become better understood when reading the following detailed description with reference to the accompanying drawings, in which like reference numbers represent like parts throughout the drawings, and wherein:

FIG. 1 is a diagram of a fluorescence guided surgical imaging system having multiple optical spectral channels according to an exemplary embodiment of the invention;

FIG. 2 is a diagram of a fluorescence guided surgical imaging system having multiple optical spectral channels according to another embodiment of the invention; and

FIG. 3 is a diagram of a fluorescence guided surgical imaging system having multiple optical spectral channels according to another embodiment of the invention.

While the drawings illustrate system components in a designated physical relation to one another or having a designated electrical communication with one another, and process steps in a particular sequence, such drawings illustrate examples of the invention and may vary while remaining within the scope of the invention.

### DETAILED DESCRIPTION

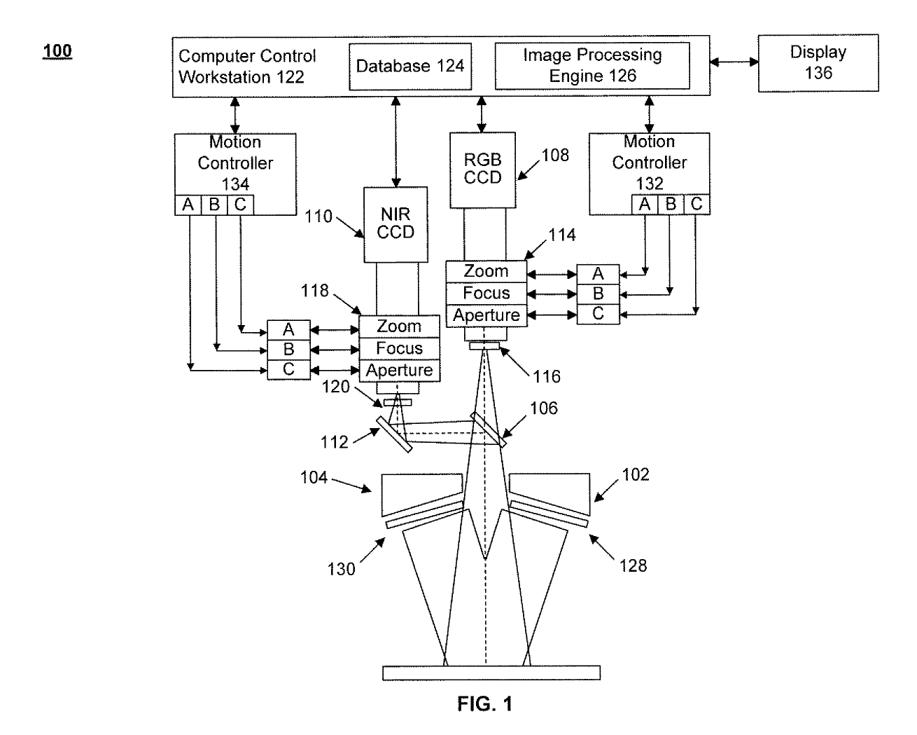

A fluorescence guided surgical imaging system, according to one embodiment of the invention, is shown in FIG. 1. The fluorescence guided surgical imaging system illustrated in FIG. 1 may utilize a fluorescent contrast agent to illuminate various vessels or tissues in the organism for surgical guidance, complication reduction, and treatment verification. The fluorescence guided surgical imaging system 100 may include a visible (e.g., red/green/blue color and/or black and white) optical spectral channel. The fluorescence guided surgical imaging system 100 may also include one or more fluorescent optical spectral channels with one or more excitation sources and one or more fluorescent emissions. However, as will be described below, other embodiments of the invention may utilize different configurations of the fluorescence guided surgical imaging system and the following detailed description of the system in FIG. 1 is merely one example of an embodiment of the invention.

As shown in FIG. 1, the fluorescence guided surgical imaging system 100 may comprise a white light source 102 and an excitation source 104 to simultaneously illuminate a surgical field with visible light and excitation light, respectively. The excitation light may comprise near-infrared (NIR) or infrared (IR) light, for example, although other wavelengths may also be used. The white light source 102 and the excitation source 104 may be mounted on either side of the surgical field, using articulating arms in order to sufficiently illuminate the surgical field. The white light source 102 and the excitation source 104 may have optical filters 128 and 130, respectively, in order to illuminate a surgical field with filtered light of desired wavelength. The fluorescence guided surgical imaging system 100 may also comprise a dichroic mirror 106 that optically couples a visible image sensor 108 to the surgical field. Also, the dichroic mirror 106 may optically couple a fluorescent image sensor 110 to the surgical field via a mirror 112. The fluorescence guided surgical imaging system 100 may further comprise an independent visible imaging optics system having a visible lens system 114 and a visible filter 116 located between the visible image sensor 108 and the surgical field. In addition, an independent fluorescent imaging optics system having a fluorescent lens system 118 and a fluorescent filter 120 may be provided for the fluorescent image sensor 110. The visible image sensor 108 and the fluorescent image sensor 110 may receive image information from the visible optical spectral channel and the fluorescent optical spectral channel, respectively, and may convert the image information into an image signal. The visible image sensor 108 and the fluorescent image sensor 110 may be referred to as “detectors” and may be digital or analog, for example. The image signal from the visible image sensor 108 and the fluorescent image sensor 110 may be transmitted to the computer control workstation 122. The computer control workstation 122 may transmit the image signal to the display 136 to be viewed by a user (e.g., a surgeon).

The independent visible imaging optics system and the independent fluorescent imaging optics system enable the fluorescence guided surgical imaging system 100 to provide independent adjustment of the field of view, position of the focal plane, and size of the optical aperture in order to achieve optical collection efficiency for each of the visible optical spectral channel and the fluorescent optical spectral channel. In an exemplary embodiment, the visible lens system 114 may include an adjustable zoom lens, focus lens, and/or optical aperture in order to adjust the size of the field of view, position of the focal plane, size of the optical aperture and depth of field. The ability to control the size of the field of view and the focus can be provided by a zoom lens and a separate focusing lens, or it can be provided by a variable focal length zoom lens, which provides both of these functions.

The visible lens system 114 may include a visible motion controller 132 coupled to the computer control workstation 122. The visible motion controller 132 may include a plurality of lines (e.g., line A, line B, line C) to provide one or more control signals to a plurality of actuators (e.g., actuator A, actuator B, actuator C) to adjust the zoom lens, the focus lens, and the optical aperture of the visible lens system 114. In an exemplary embodiment, the actuator A may independently adjust the zoom (e.g., size of a field of view) of the visible lens system 114, the actuator B may independently adjust the focus (e.g., a position of focal plane) of the visible lens system 114, and the actuator C may independent adjust the optical aperture of the visible lens system 114. The plurality of actuators may include a motor, such as a DC motor or AC motor, a piezo-actuator, and/or other mechanical device for moving or controlling the lenses and aperture. The plurality of actuators may be coupled to the visible lens system 114 via one or more mechanical links. For example, the one or more mechanical links may comprise gears, belts, and/or other devices for coupling the movements of an actuator.

The fluorescent lens system 118 may include an adjustable zoom lens, focus lens, and/or optical aperture in order to adjust the size of the field of view, position of the focal plane, size of the optical aperture and depth of field. The ability to control the size of the field of view and the focus can be provided by a zoom lens and a separate focusing lens, or it can be provided by a variable focal length zoom lens, which provides both of these functions. The fluorescent lens system 118 may include a fluorescent motion controller 134 coupled to the computer control workstation 122. The fluorescent motion controller 134 may include a plurality of lines (e.g., line A, line B, line C) to provide one or more control signals to a plurality of actuators (e.g., actuator A, actuator B, actuator C) to adjust the zoom lens, the focus lens, and the optical aperture of the fluorescent lens system 118. In an exemplary embodiment, the actuator A may independently adjust the zoom (e.g., size of a field of view) of the fluorescent lens system 118, the actuator B may independently adjust the focus (e.g., a position of focal plane) of the fluorescent lens system 118, and the actuator C may independently adjust the optical aperture of the fluorescent lens system 118. The plurality of actuators may include a motor, such as a DC motor or AC motor, a piezo-actuator, and/or other mechanical device for moving or controlling the lenses and aperture. The plurality of actuators may be coupled to the fluorescent lens system 118 via one or more mechanical links. For example, the one or more mechanical links may comprise gears, belts, and/or other devices for coupling the movements of an actuator. The visible motion controller 132 and the fluorescent motion controller 134 may provide one or more control signals to independently adjust the visible lens system 114 and the fluorescent lens system 118, respectively.

The white light source 102, according to an exemplary embodiment of the invention, may comprise a light source adapted to illuminate the organism in the surgical field with a desired range of wavelengths. For example, the white light source 102 may comprise an incandescent, halogen, or fluorescence light source, and/or other light source to generate the desired range of wavelengths. In other exemplary embodiments, the white light source 102 may comprise a xenon light source, a metal halide light source, a mercury light source, and/or any light source that sufficiently illuminates the surgical field. The white light source 102 may comprise a multitude of light sources and/or a combination of light sources, such as arrays of light emitting diodes (LEDs), lasers, laser diodes, lamps of various kinds, or other known light sources. According to one example, the white light source 102 includes one or more filters to filter out any undesired wavelengths in order to illuminate the surgical field with desired range of wavelengths of light (e.g., blocking wavelengths that are in the near-infrared (NIR) range or infrared (IR) range). In an exemplary embodiment, the white light source 102 may comprise a halogen lamp having a hot mirror located inside the white light source 102 such that the reflective surface of the hot mirror may be oriented toward the halogen lamp. The white light source 102 may also include a heat filter and a second hot mirror in order to direct the light towards the surgical field.

The excitation source 104 may be any source that emits an excitation wavelength or wavelength range capable of causing a fluorescent emission from a fluorescent substance in the organism. For example, the excitation source 104 may include light sources that use a halogen lamp, light emitting diodes, laser diodes, laser dyes, lamps, and the like. Also, the excitation source 104 may comprise a multitude of light sources and/or a combination of light sources, such as arrays of light emitting diodes (LEDs), lasers, laser diodes, lamps of various kinds, or other known light sources. In other exemplary embodiments, the excitation source 104 may be a xenon light source, a metal halide light source, a mercury light source, or any light source that sufficiently excites the fluorescent substance in the subject. In an exemplary embodiment, the excitation source 104 may be a halogen light source having one or more filters to filter out undesired wavelengths in order to illuminate the surgical field with the desired wavelengths of light (e.g., passing 725 nm-775 nm light). Also, the excitation source 104 may include one or more bandpass filters in order to achieve the desired wavelength of light. The excitation source 104 may be configured to generate a wavelength or wavelength range within and/or outside of the visible wavelengths.

During surgery, the surgeon may position the white light source 102 to illuminate a desired surgical site and to acquire reflectance images (i.e., images comprised of light reflected from the organism). The surgeon may position the excitation source 104 to excite a fluorescent contrast agent in the organism and to acquire fluorescent images of the organism. The visible image sensor 108 and the fluorescent image sensor 110 may be used to acquire image information used to generate a merged image in which a fluorescence image is superimposed on a reflectance image. The merged image may assist the surgeon in visualizing the area to be treated and in discriminating certain tissues and vessels during surgery. The independent visible imaging optics system having the independently adjustable visible lens system 114 may provide independently adjustable visible image information to the visible image sensor 108. Also, the independent visible imaging optics system having the independently adjustable fluorescent lens system 118 may provide independently adjustable fluorescent image information to the fluorescent image sensor 110. Examples of methods for creating such a merged image are disclosed, for example, in U.S. Application No. 61/039,038, filed Mar. 24, 2008, entitled “Image Processing Systems and Methods for Surgical Applications,” and U.S. application Ser. No. 12/054,214, filed Mar. 24, 2008, entitled “Systems and Methods for Optical Imaging,” both of which are hereby incorporated by reference in their entireties.

Examples of fluorescent contrast agents are known in the art and are described, for example, in U.S. Pat. No. 6,436,682 entitled “Luciferases, fluorescent proteins, nucleic acids encoding the luciferases and fluorescent proteins and the use thereof in diagnostics, high throughput screening and novelty items”; P. Varghese et al., “Methylene Blue Dye—A Safe and Effective Alternative for Sentinel Lymph Node Localization,” Breast J. 2008 Jan-Feb; 141:61-7, PMID: 18186867 PubMed—indexed for MEDLINE; F. Aydogan et al., “A Comparison of the Adverse Reactions Associated with Isosulfan Blue Versus Methylene Blue Dye in Sentinel Lymph Node Biopsy for Breast Cancer,” Am. J. Surg. 2008 Feb; 1952:277-8, PMID: 18194680 PubMed—indexed for MEDLINE; and as commercially available products such as Isosulfan Blue or Methylene Blue for tissue and organ staining.

The dichroic mirror 106 may divide or split the light reflected from the surgical field into the visible optical spectral channel for the visible image sensor 108 and the fluorescent optical spectral channel for the fluorescent image sensor 110. In another exemplary embodiment, the dichotic mirror 106 may be a beam splitter in order to split the light reflected from the surgical field into the visible optical spectral channel and the fluorescent optical spectral channel. As illustrated in FIG. 1, the dichroic mirror 106 may pass the image information from the visible optical spectral channel to the visible image sensor 108 while reflecting the image information from the fluorescent optical spectral channel to the fluorescent image sensor 110. In an exemplary embodiment, the dichroic mirror 106 may pass the visible light in the visible optical spectral channel to the visible image sensor 108 through the visible filter 116 and the visible lens system 114. Also, the dichroic mirror 106 may reflect the fluorescent light in the fluorescent optical spectral channel to the fluorescent image sensor 110 via the mirror 112, the fluorescent filter 120, and/or the fluorescent lens system 118. Also, the type of dichroic mirror 106 may be dependent upon the type of fluorescent contrast agent injected into various vessels or tissues of the organism.

The visible image sensor 108 and the fluorescent image sensor 110 may comprise any device configured to receive image data, such as a charge coupled device (CCD) camera, a photo detector, a complementary metal-oxide semiconductor (CMOS) camera, and the like. The visible image sensor 108 and the fluorescent image sensor 110 may comprise an analog or a digital image sensor. The visible image sensor 108 and the fluorescent image sensor 110 may receive the visible light and the fluorescence emission and may convert them to signals that are transmitted to an image processing engine 126 in the computer control workstation 122. Also, the visible image sensor 108 and the fluorescent image sensor 110 may have independent optical spectral filters to optimize the signal to noise ratio. In an exemplary embodiment, the visible image sensor 108 may comprise a charged coupled device (CCD) image sensor configured to receive image information from the visible optical spectral channel and to convert the image information into an image signal. The fluorescent image sensor 110 may be a charged coupled device (CCD) image sensor configured to receive image information from the fluorescent optical spectral channel and to convert the image information into an image signal. Also, the visible image sensor 108 and/or the fluorescent image sensor 110 may operate in one or more modes. For example, the visible image sensor 108 and/or the fluorescent image sensor 110 may operate in a free running mode where a display is refreshed at a rate set by the visible image sensor 108 and/or the fluorescent image sensor 110. The visible image sensor 108 and/or the fluorescent image sensor 110 may operate in a snap acquire mode where the image information received by the visible image sensor 108 and the fluorescent image sensor 110 are merged and saved to a hard disk. The visible image sensor 108 and/or the fluorescent image sensor 110 may operate in a cine acquire mode where a continuous time lapse of image information received by the visible image sensor 108 and/or the fluorescent image sensor 110 are saved to a hard disk.

The visible lens system 114 of the independent visible imaging optics system may comprise an adjustable zoom lens, focus lens, and optical aperture. The zoom lens and focus lens may also be replaced by a variable focal length zoom lens. The visible light reflected from the organism is received through the visible lens system 114. The various lenses of the visible lens system 114 may be independently adjusted via the visible motion controller 132 and the plurality of actuators (e.g., actuator A, actuator B, and/or actuator C). In an exemplary embodiment, the actuator A may independently adjust the zoom (e.g., size of a field of view) of the visible lens system 114, the actuator B may independently adjust the focus (e.g., a position of focal plane) of the visible lens system 114, and the actuator C may independent adjust the optical aperture of the visible lens system 114. The visible motion controller 132 may independently adjust the zoom lens, the focus lens and the aperture via the plurality of actuators in order to adjust the size of the field of view, the position of the focal plane, the size of the optical aperture, and the depth of field. The visible lens system 114 may be designed for manual or automatic control of these optical parameters. The visible lens system 114 may include any lens or lens system suitable for receiving light from the surgical field and independently adjusting the light for image capture by the visible image sensor 108.

The fluorescent lens system 118 of the independent fluorescent imaging optics system may comprise an adjustable zoom lens, focus lens, and optical aperture. The zoom lens and focus lens may also be replaced by a variable focal length zoom lens. The fluorescence emission emitted from the fluorescent substance in the organism is received through the fluorescent lens system 118. The various lenses of the fluorescent lens system 118 may be independently adjusted via the fluorescent motion controller 134 and the plurality of actuators (e.g., actuator A, actuator B, and/or actuator C). In an exemplary embodiment, the actuator A may independently adjust the zoom (e.g., size of a field of view) of the fluorescent lens system 118, the actuator B may independently adjust the focus (e.g., a position of focal plane) of the fluorescent lens system 118, and the actuator C may independent adjust the optical aperture of the fluorescent lens system 118. The fluorescent motion controller 134 may independently adjust the zoom lens, the focus lens and the aperture via the plurality of actuators in order to adjust the size of the field of view, the position of the focal plane, the size of the optical aperture, and the depth of field. The fluorescent lens system 118 may be designed for manual or automatic control of these optical parameters. The fluorescent lens system 118 may include any lens or lens system suitable for receiving light from the surgical field and independently adjusting the light for image capture by the fluorescent image sensor 110.

As discussed above, the dichroic mirror 106 may divide the image information into different paths or channels either spectrally or by splitting the image with a partially reflective surface. For example, the dichroic mirror 106 may divide the fluorescence emission from the reflected light. The fluorescence emission may be reflected by the mirror 112 and may travel through the fluorescent filter 120 and then be focused onto the fluorescent image sensor 110. The fluorescent filter 120 may be configured to reject the reflected visible light and the excitation light from being detected by the fluorescent image sensor 110, while allowing the fluorescent emission from the fluorescent substance in the organism to be detected by the fluorescent image sensor 110. The visible filter 116 may ensure that the excitation light and fluorescence emission are rejected from detection to allow for accurate representation of the visible reflected light image. The visible filter 116 of the independent visible imaging optics system and/or the fluorescent filter 120 of the independent fluorescent imaging optics system may each comprise a short pass filter, a bandpass filter, and/or other filters that may have a sharp transition at each cutoff point in order to filter the respective desired wavelengths of light.

The visible lens system 114 and the visible filter 116 are components of an independent visible imaging optics system for receiving image information via the visible optical spectral channel, according to an exemplary embodiment of the invention. The fluorescent lens system 118 and the fluorescent filter 120 are components of a separate independent fluorescent optics system for receiving image information via the fluorescent optical spectral channel. Each independent optics system associated with the visible optical spectral channel and the fluorescent optical spectral channel, respectively, may allow for independent adjustment of the focus of the visible optical spectral channel and the fluorescent optical spectral channel, respectively, in order to correct image errors. Also, each independent optical system associated with the visible image sensor 108 and the fluorescent image sensor 110, respectively, may be independently adjusted, aligned, magnified, and focused to allow surgeons to view the desired area of the surgical field. Moreover, the visible lens system 114 and the fluorescent lens system 118 may be independently adjusted and therefore may achieve an optimal setting for the visible optical spectral channel and the fluorescent optical spectral channel.

As discussed above, the visible image sensor 108 and the fluorescent image sensor 110 may be electrically coupled to the computer control workstation 122. The computer control workstation 122 may display visible images and/or fluorescent images via the display 136. The visible motion controller 132 and the fluorescent motion controller 134 may be electrically coupled to the computer control workstation 122. The computer control workstation 122 may include one or more databases 124 in order to receive image information from the visible optical spectral channel and the fluorescent optical spectral channel. The computer control workstation 122 may also include one or more control software programs that allow for independent adjustment of the imaging optics systems associated with the visible image sensor 108 and the fluorescent image sensor 110. In an exemplary embodiment, the computer control workstation 122 may provide a number of functions, such as power conditioning, user interface(s) (such as a mouse, touch screen, display device, foot pedals, keyboard, voice inputs, etc.), network interface(s) (e.g., DICOM, networking, archiving, printing, etc.), and an interface to one or more video display devices. The computer control workstation 122 may display the image information received from the visible optical spectral channel and the fluorescent optical spectral channel on separate video display devices. Also, the computer control workstation 122 may display the image information received from the visible optical spectral channel and the fluorescent optical spectral channel on a single video display device. The computer control workstation 122 may also provide image processing and data storage functionality that may be utilized by the fluorescence guided surgical imaging system 100.

In an exemplary embodiment, the computer control workstation 122 may control one or more operations of the fluorescence guided surgical imaging system 100. For example, the computer control workstation 122 may control the timing and operation of the fluorescence guided surgical imaging system 100, the types of data acquisition, and the data flow. The computer control workstation 122 may receive video signals from the visible image sensor 108 and the fluorescent image sensor 110 and process the video signals. The computer control workstation 122 may include an image processing engine 126 (e.g., a software module that runs on the computer control workstation 122 and/or additional hardware) that may execute various image processing routines on the data acquired from the visible image sensor 108 and the fluorescent image sensor 110, such as those routines disclosed in the aforementioned U.S. Application No. 61/039,038 and Ser. No. 12/054,214. The image processing engine 126 may utilize a database 124 associated with the computer control workstation 122 for storing, among other things, image information and various computer programs for image processing. The database 124 may be provided in various forms, such as RAM, ROM, hard drive, flash drive, etc. The database 124 may comprise different components for different functions, such as a first component for storing computer programs, a second component for storing image information, etc. The image processing engine 126 may include hardware, software or a combination of hardware and software. The image processing engine 126 is programmed to execute various image processing methods. The methods typically involve acquiring frames of image information at different points in time. According to one embodiment, the frames of image information include image information from the visible optical spectral channel and image information from the fluorescent optical spectral channel. The image information sent from the visible optical spectral channel and the fluorescent optical spectral channel may be used to generate a merged image in which the image information from the fluorescent optical spectral channel is overlaid onto the image information from the visible optical spectral channel. The merged image may assist and guide the surgeon in visualizing certain tissues which emit fluorescent light during surgery.

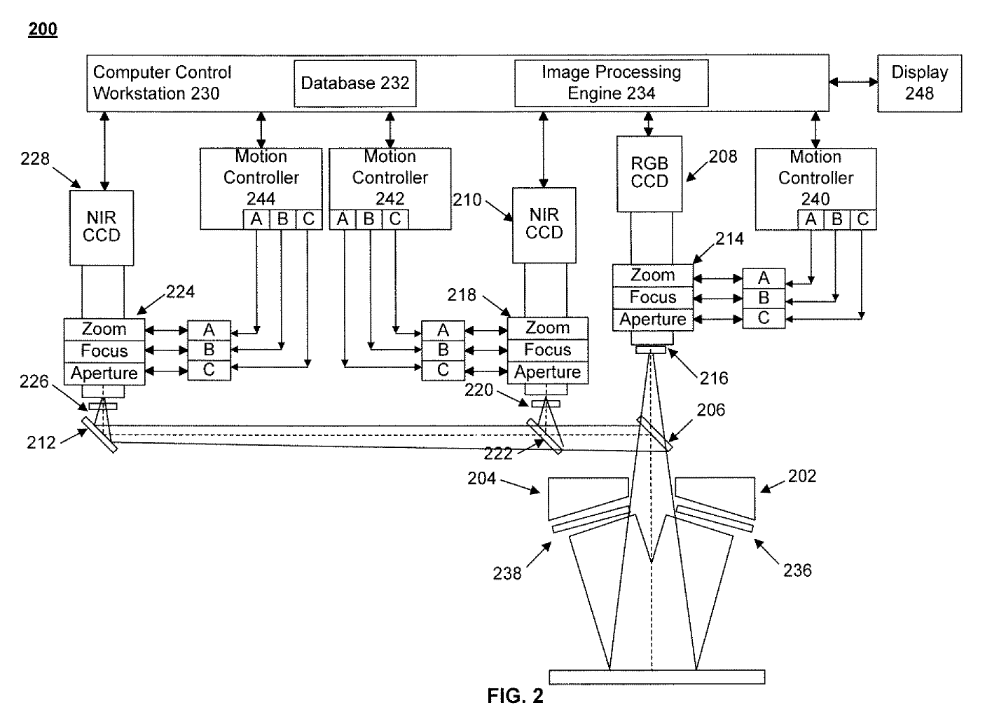

FIG. 2 illustrates a diagram of a fluorescence guided surgical imaging system 200 having an independent visible imaging optics system and two independent fluorescent imaging optics systems according to another embodiment of the invention. The fluorescence guided surgical imaging system 200 may have similar components and operate in a similar fashion as the fluorescence guided surgical imaging system 100 illustrated in FIG. 1. For example, the fluorescence guided surgical imaging system 200 may include a white light source 202 and an excitation source 204 to simultaneously illuminate a surgical field with visible light (e.g., 400 nm to 700 nm) and near-infrared (NIR) or infrared (IR) excitation light (e.g., 675 nm to 1700 nm), respectively. The excitation source 204 in FIG. 2 may include a plurality of sub-excitation sources and each of the plurality of sub-excitation sources may illuminate the surgical field with light of different wavelengths. For example, the plurality of sub-excitation sources may illuminate the surgical field with light of different wavelengths in order to excite various fluorescent contrast agents. The white light source 202 and the excitation source 204 may be mounted on either side of the surgical field, using articulating arms in order to sufficiently illuminate the surgical field. The white light source 202 and the excitation source 204 may have optical filters 236 and 238, respectively, in order to illuminate a surgical field with filtered light of desired wavelength. The fluorescence guided surgical imaging system 200 may also comprise a channeling dichroic mirror 206 that may optically couple an image sensor 208 (e.g., color or black and white) to the surgical field.

Also, the channeling dichroic mirror 206 may optically couple a first fluorescent image sensor 210 and a second fluorescent image sensor 228 to the surgical field via a dividing dichroic mirror 222 and a mirror 212. The channeling dichroic mirror 206 may divide light emanating from the surgical site into the visible optical spectral channel for the visible image sensor 208, and the fluorescent optical spectral channels for the fluorescent image sensors. The dividing dichroic mirror 222 may further divide the first fluorescent optical spectral channel from the second fluorescent optical spectral channel. In an exemplary embodiment, the dividing dichroic mirror 222 may divide the first fluorescent optical spectral channel having a first wavelength or wavelength range associated with the first fluorescent image sensor 210 and the second fluorescent optical spectral channel having a second wavelength or wavelength range associated with the second fluorescent image sensor 228. For example, the first wavelength or wavelength range of the first fluorescent optical spectral channel may be different from the second wavelength or wavelength range of the second fluorescent optical spectral channel.

The fluorescence guided surgical imaging system 200 may further comprise an independent visible optics system having a visible lens system 214 and a visible filter 216 located between the visible image sensor 208 and the surgical site. Also, a first independent fluorescent optics system having a first fluorescent lens system 218 and a fluorescent filter 220 may be provided in front of the first fluorescent image sensor 210. In addition, a second independent fluorescent optics system having a second fluorescent lens system 224 and a fluorescent filter 226 may be provided in front of the second fluorescent image sensor 228. The independent visible optics system, the independent first independent fluorescent optics system, and the independent second independent fluorescent optics system may enable the fluorescence guided surgical imaging system 200 to provide independent adjustment of the size of the field of view, the position of the focal plane, and the size of the optical aperture in order to achieve optical collection efficiency for each of the visible optical spectral channel, the first fluorescent optical spectral channel, and the second fluorescent optical spectral channel. These independent optics systems operate in a similar manner to those corresponding systems described above in connection with FIG. 1. The independent visible imaging optics system and the first and second independent fluorescent imaging optics systems may enable the fluorescence guided surgical imaging system 200 to provide independent adjustment of the field of view, the position of focal plane, and the optical aperture in order to achieve an optimal optical setting for each of the visible optical spectral channel, the first fluorescent optical spectral channel, and the second fluorescent optical spectral channel.

The visible image sensor 208, the first fluorescent image sensor 210, and/or the second fluorescent image sensor 228 may receive image information, respectively, from the visible optical spectral channel, the first fluorescent optical spectral channel, and the second fluorescent optical spectral channel, and may convert the image information into image signals. The image signals from the visible image sensor 108, the first fluorescent image sensor 210, and the second fluorescent image sensor 228 may be transmitted to the computer control workstation 230 to be processed by image processing engine 232 and stored in database 234. The computer control workstation 230 may display visible images and/or fluorescent images via the display 248.

In an exemplary embodiment, the second fluorescent lens system 224 may include an adjustable zoom lens, focus lens, and/or optical aperture in order to adjust the size of a field of view, a position of focal plane, and optical aperture. The fluorescent lens system 224 may include a second fluorescent motion controller 244 coupled to the computer control workstation 230. The second fluorescent motion controller 244 may be similar to the visible motion controller 240 and/or the first fluorescent motion controller 242 and may include a plurality of lines (e.g., line A, line B, line C) to provide one or more control signals to a plurality of actuators (e.g., actuator A, actuator B, actuator C) to adjust the zoom lens, the focus lens, and the aperture of the second fluorescent lens system 224. The plurality of actuators may include a motor, such as a DC motor or AC motor, a piezo-actuator, and/or other mechanical device for moving or controlling the lenses and aperture. The plurality of actuators may be coupled to the second fluorescent lens system 224 via one or more mechanical links. For example, the one or more mechanical links may comprise gears, belts, and/or other devices for coupling the movements of an actuator. The second fluorescent motion controller 244 may provide one or more control signals to independently adjust the second fluorescent lens system 224 in order to independently adjust the size of a field of view, a position of focal plane, and an optical aperture.

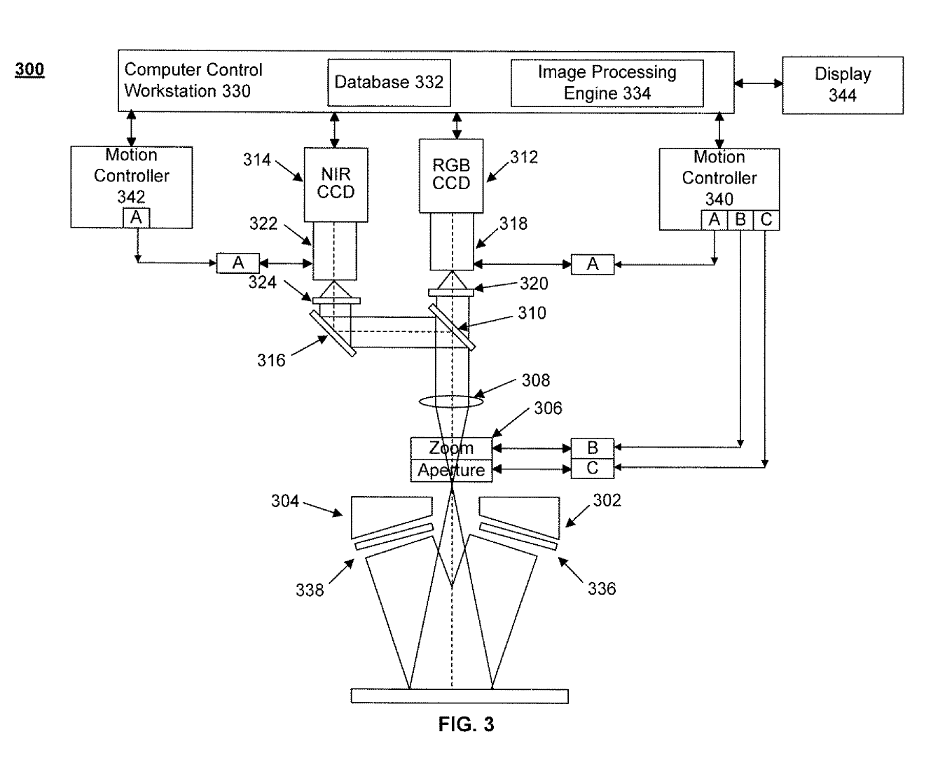

FIG. 3 illustrates a diagram of a fluorescence guided surgical imaging system 300 having multiple optical spectral channels according to another embodiment of the invention. The fluorescence guided surgical imaging system 300 has similar components and operates in a similar fashion as the fluorescence guided surgical imaging system 100 illustrated in FIG. 1. For example, the fluorescence guided surgical imaging system 300 may include a white light source 302 and an excitation source 304 to simultaneously illuminate a surgical field with visible light (e.g., 400 nm to 700 nm) and near-infrared (NW) or infrared (IR) excitation light (e.g., 675 nm to 1700 nm), respectively. The white light source 302 and the excitation source 304 may be mounted on either side of the surgical field using articulating arms in order to sufficiently illuminate the surgical field. The white light source 302 and the excitation source 304 may have optical filters 336 and 338, respectively, in order to illuminate the surgical field with filtered light of desired wavelength. The fluorescence guided surgical imaging system 300 may also comprise a lens system 306, a relay lens 308, a dichroic mirror 310, and/or a mirror 316 that may optically couple a visible image sensor 312 and a fluorescent image sensor 314 to the surgical field.

The lens system 306 may include an adjustable zoom lens and optical aperture, for example. The lens system 306 may be controlled by the visible motion controller 340 (B and C), for example. An adjustment of the lens system 306 by the visible motion controller 340 (B and C) may simultaneously adjust the image information from the visible optical spectral channel and the fluorescent optical spectral channel. The relay lens 308 may be a lens or a lens system that may transfer images from the surgical field to the dichroic mirror 310. Also, the relay lens 308 may or may not magnify the images from the surgical field. The relay lens 308 may have a right-angled configuration at the corner to produce a sharp and stable image for the fluorescence guided surgical imaging system 300. The dichroic mirror 310 may divide light emanating from the surgical field into the visible optical spectral channel for the visible image sensor 312 and the fluorescent optical spectral channel for the fluorescent image sensor 314.

The fluorescence guided surgical imaging system 300 may further comprise an independent visible imaging optic system having a visible focus lens 318 and a visible filter 320 located between the visible image sensor 312 and the surgical field, and an independent fluorescence imaging optic system having a fluorescent focus lens 322 and a fluorescent filter 324 located between the fluorescent image sensor 314 and the surgical field. The visible focus lens 318 and the fluorescent focus lens 322 may be independently controlled by the visible motion controller 340 and the fluorescent motion controller 342, respectively. The visible motion controller 340 and the fluorescent motion controller 342 may independently adjust a position of focal plane of the surgical field. The visible motion controller 340 may include a line (e.g., line A) to provide one or more control signals to an actuator (e.g., actuator A) to adjust the visible focus lens 318. The actuator may include a motor, such as a DC motor or AC motor, a piezo-actuator, and/or other mechanical device for moving or controlling the visible focus lens 318. The actuator may be coupled to the visible focus lens 318 via one or more mechanical links. For example, the one or more mechanical links may comprise gears, belts, and/or other devices for coupling the movements of an actuator. The fluorescent motion controller 342 may include a line (e.g., line A) to provide one or more control signals to an actuators (e.g., actuator A) to adjust the fluorescent focus lens 322. The actuator may include a motor, such as a DC motor or AC motor, a piezo-actuator, and/or other mechanical device for moving or controlling the fluorescent focus lens 322. The actuator may be coupled to the fluorescent focus lens 322 via one or more mechanical links. For example, the one or more mechanical links may comprise gears, belts, and/or other devices for coupling the movements of an actuator. By providing independently controlled imaging optics systems including the visible focus lens 318 and the fluorescent focus lens 322, respectively, the fluorescence guided surgical imaging system 300 may provide independent focus adjustment to view the surgical field in order to achieve a desired optical setting for each of the visible optical spectral channel and the fluorescent optical spectral channel.

The visible image sensor 312 and the fluorescent image sensor 314 may receive image information from the visible optical spectral channel and the fluorescent optical spectral channel, respectively, and may convert the image information into an image signal. The image signal from the visible image sensor 312 and the fluorescent image sensor 314 may be transmitted to the computer control workstation 330 to be processed by image processing engine 332 and stored in database 334. The workstation 330 may transmit image signal to the display 344 to be viewed by a user (e.g., surgeon).

The embodiment shown in FIG. 3 depicts an example of a system in which the focus lenses 318, 322 are independently controlled for the visible channel and the fluorescent channel, respectively, while a single zoom lens and aperture 306 are provided for the two channels. In other embodiments (not shown), a different configuration of common and independently controlled elements may be provided. For example, the zoom and the focus may be independently controlled, the zoom and the aperture may be independently controlled, or the focus and the aperture may be independently controlled.

While the foregoing description includes details and specific examples, it is to be understood that these have been included for purposes of explanation only, and are not to be interpreted as limitations of the present invention. For example, there are various types of image data and sensors that may be used in various embodiments of the present invention. In addition, although the above-described embodiments relate primarily to human surgical applications, exemplary embodiments of the present invention may be adapted for non-surgical, animal or other applications. Modifications to the embodiments described herein may be made without departing from the spirit and scope of the invention, which is intended to be encompassed by the following claims and their legal equivalents.

1. An imaging system comprising:
a visible light source configured to illuminate a surgical field with visible light;
an excitation source configured to generate excitation light to excite a fluorescent substance in an organism within the surgical field;
a first sensor that receives visible light reflected from the surgical field via a first spectral channel;
a second sensor that receives a fluorescent emission emitted from the fluorescent substance in the organism via a second spectral channel;
a visible imaging optics system that optically couples the surgical field to the first sensor and that provides independent adjustment of at least one of the following optical parameters: a size of a field of view, a position of a focal plane, and a size of an optical aperture;
a fluorescent imaging optics system that optically couples the surgical field to the second sensor and that provides independent adjustment of at least one of the following optical parameters: a size of a field of view, a position of a focal plane, and a size of an optical aperture;
and a control unit configured to receive image signals from the first sensor and the second sensor and to generate a plurality of image frames.

2. The system of claim 1, wherein the first sensor comprises at least one of a charge coupled device (CCD) and a complementary metal-oxide semiconductor (CMOS) camera.

3. The system of claim 1, wherein the second sensor comprises at least one of a charge coupled device (CCD) and a complementary metal-oxide semiconductor (CMOS) camera.

4. The system of claim 1, wherein the visible light source comprises at least one of a lamp, a light emitting diode (LED), a supercontinuum laser, and a fluorescence light source.

5. The system of claim 1, wherein the excitation source comprises at least one of a light emitting diode (LED), a laser, a laser diode, and a lamp.

6. The system of claim 1, wherein the visible imaging optics system comprises a visible filter that blocks the excitation light from an excitation.

7. The system of claim 1, wherein the fluorescent imaging optics system comprises a fluorescent filter that blocks the visible light reflected from the organism.

8. The system of claim 1, wherein the visible imaging optics system comprises a visible lens system and the fluorescent imaging optics system comprises a fluorescent lens system.

9. The system of claim 8, wherein the visible imaging optics system comprises at least one of an adjustable zoom lens, an adjustable focus lens, and an adjustable aperture.

10. The system of claim 8, wherein the fluorescent imaging optics system comprises at least one of an adjustable zoom lens, an adjustable focus lens, and an adjustable aperture.

11. The system of claim 1, wherein the excitation light comprises near-infrared light or infrared light.

12. The system of claim 1, further comprising a visible motion controller coupled to the visible imaging optics system and a fluorescent motion controller coupled to the fluorescent imaging optics system.

13. The system of claim 12, wherein the visible motion controller automatically controls the visible imaging optics system, and the fluorescent motion controller automatically controls the fluorescent imaging optics system.

14. The system of claim 1, wherein a user manually controls the visible imaging optics system and the fluorescent imaging optics system.

15. The system of claim 1, wherein the visible imaging optics system is configured to independently control the size of the field of view, the position of the focal plane, and the size of the optical aperture, and the fluorescent imaging optics system is configured to independently control the size of the field of view, the position of the focal plane, and the size of the optical aperture.

16. The system of claim 1, wherein two of the following optical parameters are commonly controlled: the size of the field of view, the position of the focal plane, and the size of the optical aperture.

17. The system of claim 1, wherein one of the following optical parameters is commonly controlled: the size of the field of view, the position of the focal plane, and the size of the optical aperture.

18. The system of claim 1, further comprising:
a third sensor that receives a second fluorescent emission; and
a second fluorescent imaging optics system that optically couples the surgical field to the third sensor and that provides independent adjustment of at least one of the following optical parameters: a size of a field of view, a position of a focal plane, and a size of an optical aperture;
and wherein the excitation light comprises a first excitation wavelength band and a second excitation wavelength band.

19. The system of claim 1, wherein
the visible imaging optics system comprises a zoom lens and a focus lens to control the size of the field of view and the position of the focal plane; and
the fluorescent imaging optics system comprises a zoom lens and a focus lens to control the size of the field of view and the position of the focal plane.

20. The system of claim 1, wherein
the visible imaging optics system comprises a variable focal length zoom lens to control the size of the field of view and the position of the focal plane; and
the fluorescent imaging optics system comprises a variable focal length zoom lens to control the size of the field of view and the position of the focal plane.
